(19) United States
(12) Patent Application Publication
(10) Pub. No.: US 2017/0288967 A1
(43) Pub. Date: Oct. 5, 2017

(54) ENVIRONMENT MANAGER FOR CONTINUOUS DEPLOYMENT

(71) Applicant: CA, Inc., Islandia, NY (US)

(72) Inventors: Shozab H. Naqvi, Dix Hills, NY (US); Bryan Perino, Smithtown, NY (US); Tony Tsai, Oakland Gardens, NY (US)

(21) Appl. No.: 15/087,701

(22) Filed: Mar. 31, 2016

(51) Int. Cl. H04L 12/24; H04L 12/911; G06F 3/0482; G06F 17/27; G06F 17/24

(52) U.S. Cl. CPC H04L 41/0893; G06F 17/2705; G06F 17/248; G06F 3/0482; H04L 41/20; H04L 47/70

(57) ABSTRACT

Aspects of the embodiments are directed to designing a deployment environment for a continuous delivery tenant. Embodiments include receiving, via a natural language input, a set of parameters for building a deployment environment for an application; determining, by a natural language processing engine, a resource to satisfy a parameter of the set of parameters; identifying, for a resource, a resource provider for providing the resource; and installing, via a network interface, the application on the resource provider.

### TECHNICAL FIELD

This disclosure pertains to an environment manager for facilitating continuous deployment.

### BACKGROUND

In the end to end continuous delivery process, various aspects of application development and deployment are handled by separate, point solutions. For example, the application build, environment/resource creation, resource configuration, application deployment, application testing/verifications and application promotion can each be handled by a separate resource provider.

### SUMMARY

Aspects of the embodiments are directed to a method for designing a deployment environment for a continuous delivery tenant. The method includes receiving, via a natural language input, a set of parameters for building a deployment environment for an application; determining, by a natural language processing engine, a resource to satisfy a parameter of the set of parameters; identifying, for a resource, a resource provider for providing the resource; and installing, via a network interface, the application on the resource provider.

Aspects of the embodiments are directed to a computer program product comprising a computer readable storage medium comprising computer readable program code embodied therewith. The computer readable program code including computer readable program code configured to receive, via a natural language input, a set of parameters for building a deployment environment for an application; computer readable program code configured to determine, by a natural language processing engine, a resource to satisfy a parameter of the set of parameters; computer readable program code configured to identify a resource provider for providing the resource; and computer readable program code configured to install, via a network interface, the application on the resource provider.

Aspects of the embodiments are directed to a system for provisioning resource for application deployment. The system includes an environment manager server comprising a release automation agent, the environment manager server configured to receive a selection for a stack template, the stack template including a resource for defining a deployment environment; instantiate the stack template to identify the resource for defining the deployment environment; and transmit a request for provisioning of the resource to an environment management server; receive the request for provisioning of the resource; determine a resource provider for the resource based on a policy associated with the application; and provide the resource to the release automation server to satisfy the request for provisioning of the resource.

In some embodiments, identifying a resource provider comprises identifying a resource provider based on a policy associated with the tenant.

In some embodiments, identifying a resource provider comprises identifying a resource provider based on the application.

In some embodiments, identifying a resource provider comprises identifying a resource provider based on the set of parameters.

In some embodiments, the environmental parameters comprises an identification of the application to be run in the environment.

6 In some embodiments, the natural language input comprises a YAML Ain't Markup Language (YAML) file, and wherein the natural language processing engine comprises a YAML engine.

In some embodiments, identifying, for each resource, a resource provider for providing the resource comprises identifying a resource provider based on a policy associated with the tenant, the application to be deployed, the set of parameters, resource providers available, or resources available.

Some embodiments may also include provisioning the resource provider to provide the resource for the application; and configuring the resource based on the set of parameters.

Some embodiments may also include creating a template of a deployment resource architecture based on the tenant, the application, the received set of parameters, the resources, or an available set of resource providers, and storing the template in a repository.

Some embodiments may also include providing a user selectable interface for selecting the template of the deployment resource architecture; receiving an indication of a user selection of the deployment resource architecture; and displaying information about the deployment resource architecture, the information comprising the set of parameters and a set of resource providers.

Some embodiments may also include receiving a new parameter or new resource provider to augment the information about the deployment resource architecture; and storing a new version of the template that comprises the new parameter or new resource provider.

### BRIEF DESCRIPTION OF THE DRAWINGS

FIG. 1 is a schematic diagram of a system for managing continuous deployment in accordance with embodiments of the present disclosure.

FIG. 2 is an example screenshot of an environment manager interface in accordance with embodiments of the present disclosure.

FIG. 3 is an example screenshot of a set of resource architecture templates in accordance with embodiments of the present disclosure.

FIG. 4 is an example screenshot of an interface for reserving resources at a resource provider to application deployment using a resource architecture template instance in accordance with embodiments of the present disclosure.

FIG. 5 is a process flow diagram for defining a resource architecture in accordance with embodiments of the present disclosure.

### DETAILED DESCRIPTION

This disclosure pertains to a environmental manager to support different aspects of continuous delivery, such as building an application, setting up an environment to support application deployment, deployment of the application, testing the application, and promoting the application. Embodiments include using human readable descriptive language, such as YAML Ain't Markup Language (YAML). YAML based orchestration for continuous delivery can facilitate a simplified form of integrating existing solutions end to end.

The environment manager supports multi-tenancy by allowing each tenant to define application deployment resource architecture using a natural language input. The environment manager makes use of a natural language engine (e.g., YAML engine) to interpret the environmental requirements from a natural language input.

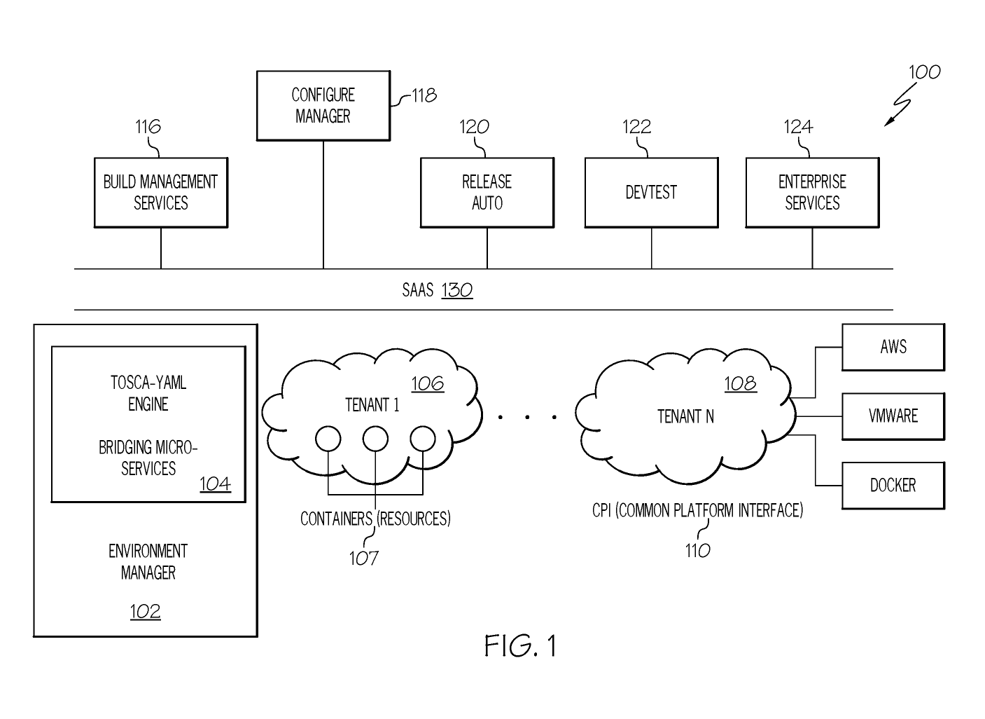

FIG. 1 is a schematic diagram of a system 100 for managing continuous deployment in accordance with embodiments of the present disclosure. The system 100 includes an environment manager 102 implemented at least partially in hardware, such as on a computer, server, workstation, or other hardware computing device. The environment manager 102 can utilize a natural language engine 104 implemented at least partially in hardware to process a natural language input and interpret the contents of a natural language input. For example, the natural language engine 104 can include a TOSCA-YAML engine. YAML is a high level human readable language used in defining/describing the environment required for doing continuous delivery and orchestrating services needed to support continuous delivery. Topology and Orchestration Specification for Cloud Applications (TOSCA) is a specification for defining a node or deployment environment. The TOSCA specification is platform independent. The TOSCA specification and YAML facilitate the a tenant to be able to define hardware requirements such as CPU and memory and what applications to install, etc., as well as other resource requirements, such as web services, operating systems, cloud services, etc.

The environment manager 102 is configured to receive a natural language input from a tenant or from a developer or other user. The natural language processing engine 104 can parse the natural language input to identify configuration parameters, such as the application for deployment, resource requirements for deploying the application (e.g., hardware resources, software resources, network resources, etc.), preferred resource providers, other policies associated with the tenant, time and duration of the deployment to reserve resources provided by a resource provider, etc.

The environment manager 102 can support multiple tenants, such as tenant 1 106 through tenant N 108. Each tenant can be associated with a container 107. A container 107 can include a running instance of resource created from a predefined or user defined stack. The term “stack” is used here to refer to a resource architecture for deploying an application. Each tenant can be associated with one or more containers 107. A resource can include any type of hardware, communications, or software resource needed for application deployment. For example, a resource can include a common platform interface (CPI) 109. Examples of a CPI can include VMWare, AWS, Docker, (CloudFoundry, including Pivotal, and IBM BlueMix), Azure, OpenStack, OpenShift, and Google, etc.

The environment manager 102 can utilize Software as a Service (SaaS) 130 topology for managing continuous delivery. SaaS 130 includes network architecture to facilitate communications to and from remote resource providers, such as build management services 116, configuration management 118, release automation 120, devTest 122, and enterprise services 124.

The environment manager 102 can communicate with remote resource providers to reserve and provision services, and deploy applications.

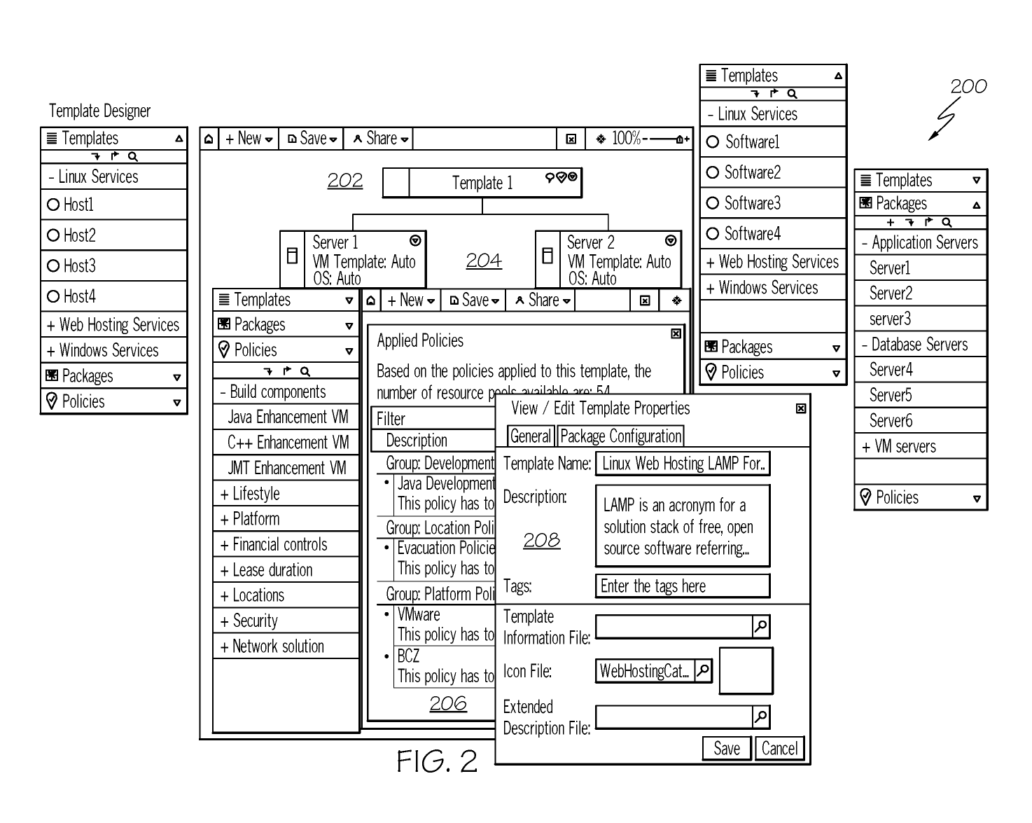

FIG. 2 is an example screenshot of an environment manager interface 200 in accordance with embodiments of the present disclosure. The environment manager interface provides an interactive graphical icon of a resource architecture template 202. The resource architecture template 202 can be explored by hovering over the icon or selecting a “view” button. The details of the resource architecture template 202 can be displayed on the interface 200. For example, the various service servers 204 that can be used for the resource architecture can be displayed. The details of each server 206 can also be shows.

Additionally, the template properties 208 can be shown to the user via the interface 200. The properties can be edited using natural language. For example, a user can edit the preferred set of resources by inputting in natural language descriptions of preferred (or required) resources. The user-defined resource architecture can be stored as a new template.

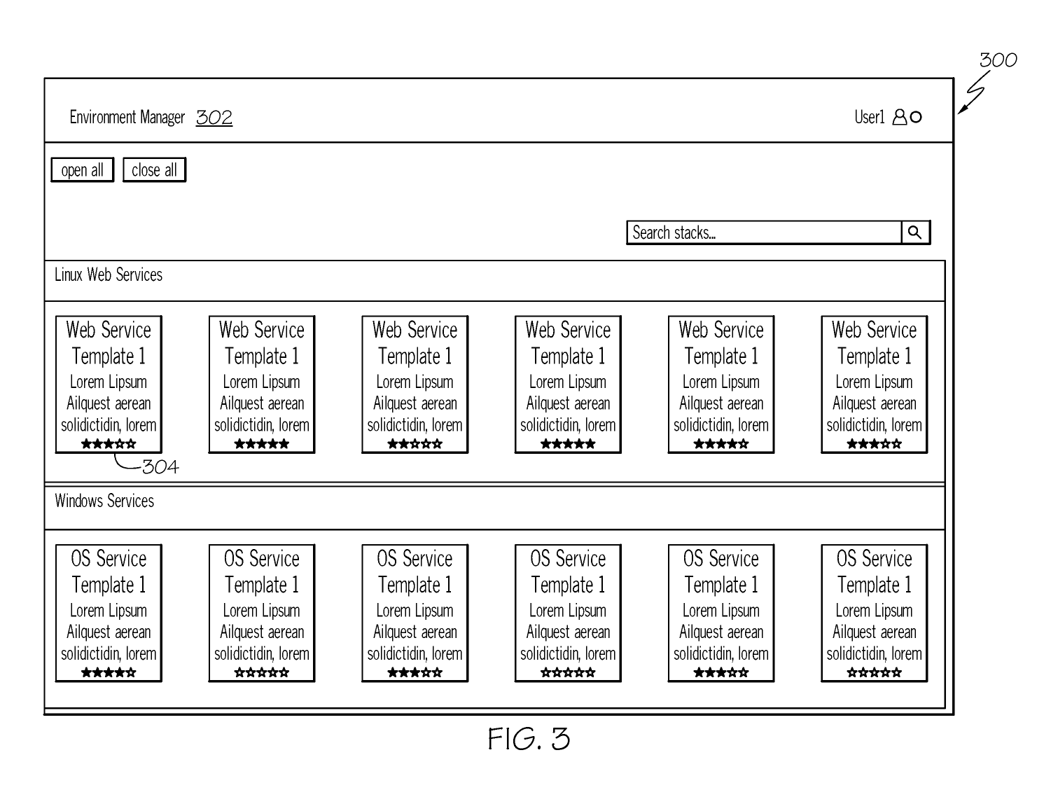

FIG. 3 is an example screenshot 300 of a set of resource architecture templates 302 in accordance with embodiments of the present disclosure. Resource architecture templates, such as template 302 can be predefined or can be user defined. Additionally, each template can be edited by a tenant user to conform to user preferences. The templates can be represented by icons that include additional information, such as a rating,

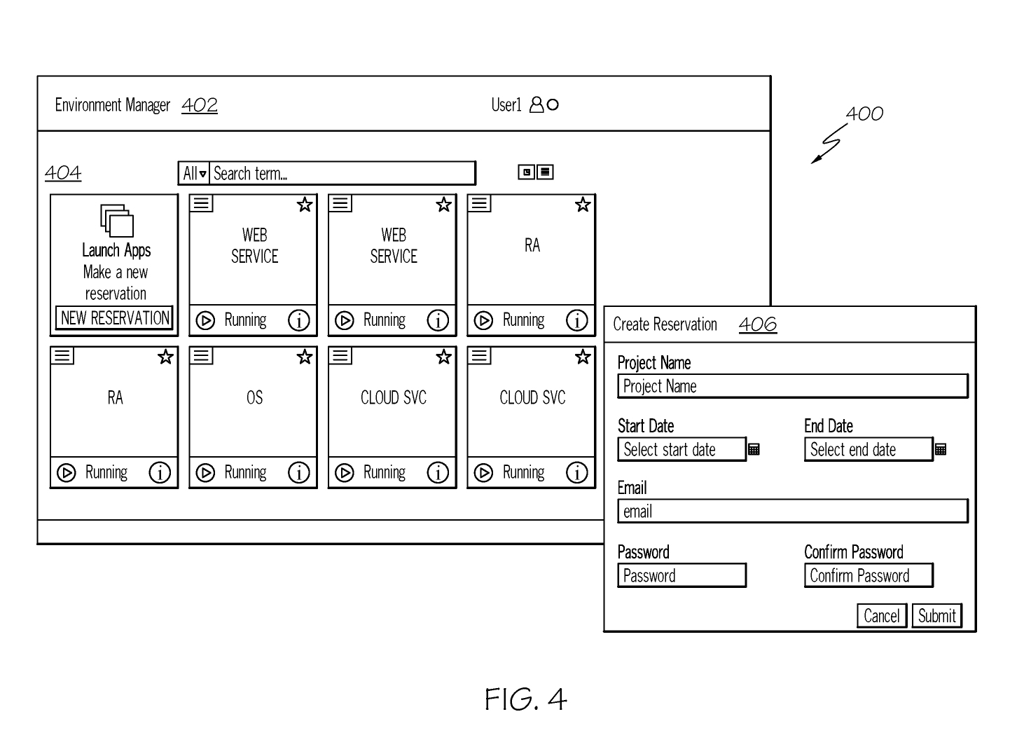

FIG. 4 is an example screenshot of an interface 400 for reserving resources at a resource provider to application deployment using a resource architecture template instance in accordance with embodiments of the present disclosure. The environment manager 402 can display one or more resource stacks 404 for a specific application deployment. Selecting a new reservation for a stack can open a dialog box 406 for making a new reservation of resources. The user can populate the dialog box 406 to define a project name, create a start and end date, and provide authentication credentials. The start and end date can be used by the environment manager to identify a resource provider for providing a resource. For example, if a resource provider is preferred by the tenant, but cannot provide the required resources during the time and duration specified, the environment manager 402 can identify an alternative resource provider that can provide the same or analogous resources.

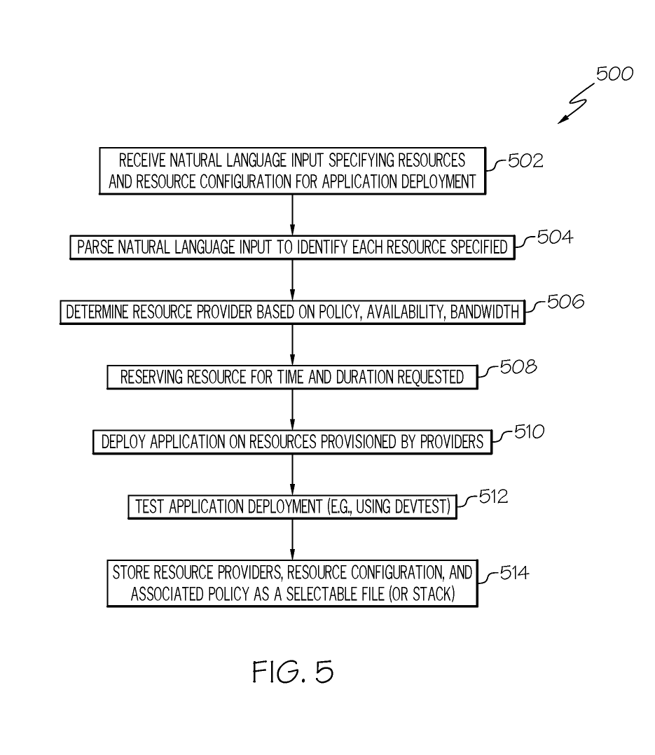

FIG. 5 is a process flow diagram 500 for defining a resource architecture in accordance with embodiments of the present disclosure. The environment manager can receive a natural language (e.g., YAML) input specifying resources and a resource configuration for application deployment (502). For example, a tenant can provide a file that includes a natural language set of parameters that include resource configuration information, application information, resource provider information, tenant information, etc. The natural language engine can parse the natural language input to identify a resource or multiple resources specified (504). The environment manager can define a resource architecture (or environment) for deploying the application. For example, the environment manager can determine the resource for deployment (as in 504 above). The environment manager can also identify a resource provider for providing the resource (506). The environment manager can use information about the tenant, such as a tenant policy or preference, to determine a resource provider. The environment manager can also use information about the application, the duration of the resource reservation, the availability of resource providers, and other information to identify a resource provider for a required resource. The environment manager can reserve the resource at the identified resource provider (508). The environment manager can deploy the application using the resource provider (510). In some embodiments, the environment manager can use a release automation service to deploy the application.

In some embodiments, the environment manager can test the resource architecture (512). The environment manager can use devTest to test the deployment.

The environment manager can store the resource architecture as a template (514). The template can include the resource architecture information, such as resource providers identified, resource configuration, associated policies, etc. The template can be stored with an associated selectable icon, which can provide a user with readable and editable resource architecture information.

What is claimed is:

1. A method for designing a deployment environment for a continuous delivery tenant, the method comprising:
receiving, via a natural language input, a set of parameters for building a deployment environment for an application;
determining, by a natural language processing engine, a resource to satisfy a parameter of the set of parameters;
identifying, for a resource, a resource provider for providing the resource; and
installing, via a network interface, the application on the resource provider.

2. The method of claim 1, wherein identifying a resource provider comprises identifying a resource provider based on a policy associated with the tenant.

3. The method of claim 1, wherein identifying a resource provider comprises identifying a resource provider based on the application.

4. The method of claim 1, wherein identifying a resource provider comprises identifying a resource provider based on the set of parameters.

5. The method of claim 1, wherein the environmental parameters comprises an identification of the application to be run in the environment.

6. The method of claim 1, wherein the natural language input comprises a YAML Ain't Markup Language (YAML) file, and wherein the natural language processing engine comprises a YAML engine.

7. The method of claim 2, wherein identifying, for each resource, a resource provider for providing the resource comprises identifying a resource provider based on a policy associated with the tenant, the application to be deployed, the set of parameters, resource providers available, or resources available.

8. The method of claim 1, further comprising provisioning the resource provider to provide the resource for the application; and configuring the resource based on the set of parameters.

9. The method of claim 1, further comprising creating a template of a deployment resource architecture based on the tenant, the application, the received set of parameters, the resources, or an available set of resource providers, and
storing the template in a repository.

10. The method of claim 9, further comprising:
providing a user selectable interface for selecting the template of the deployment resource architecture;
receiving an indication of a user selection of the deployment resource architecture; and
displaying information about the deployment resource architecture, the information comprising the set of parameters and a set of resource providers.

11. The method of claim 10, further comprising:
receiving a new parameter or new resource provider to augment the information about the deployment resource architecture; and
storing a new version of the template that comprises the new parameter or new resource provider.

12. A computer program product comprising a computer readable storage medium comprising computer readable program code embodied therewith, the computer readable program code comprising:
computer readable program code configured to receive, via a natural language input, a set of parameters for building a deployment environment for an application;
computer readable program code configured to determine, by a natural language processing engine, a resource to satisfy a parameter of the set of parameters;
computer readable program code configured to identify a resource provider for providing the resource; and
computer readable program code configured to install, via a network interface, the application on the resource provider.

13. The computer program product of claim 12, wherein computer readable program code configured to identify a resource provider comprises computer readable program code configured to identify a resource provider based on a policy associated with the tenant.

14. The computer program product of claim 12, wherein the natural language input comprises a YAML Ain't Markup Language (YAML) file, and wherein the natural language processing engine comprises a YAML engine.

15. A system for provisioning resource for application deployment, the system comprising:
an environment manager server comprising a release automation agent, the release automation server configured to:
receive a selection for a stack template, the stack template including a resource for defining a deployment environment;
instantiate the stack template to identify the resource for defining the deployment environment; and
transmit a request for provisioning of the resource to an environment management server;
receive the request for provisioning of the resource;
determine a resource provider for the resource based on a policy associated with the application; and
provide the resource to a release automation server to satisfy the request for provisioning of the resource, and
a release automation server configured to deploy the application on the resource.

16. The system of claim 15, wherein the request for a resource comprises a natural language file that includes a description of the resource to deploy the application, and wherein the environment manager comprises a natural language engine implemented at least partially in hardware to interpret the natural language description of the resource.

17. The system of claim 15, wherein the environment manager is configured to determine, based on a policy associated with the application or a tenant running the application, the resource provider for providing the resource to run the application.

18. The system of claim 15, wherein the environment management server is configured to communicate with a service provider across a network to request provisioning of resources for the application deployment.

19. The system of claim 15, wherein the release automation agent is configured to associate the resource with a server type for deployment of the application.

20. The system of claim 15, wherein the provisioning of a resource comprises reserving the resource for a predetermined time and duration.
